(19) United States
(12) Patent Application Publication
(10) Pub. No.: US 2025/0214470 A1
(43) Pub. Date: Jul. 3, 2025

(54) STORAGE AND RETRIEVAL SYSTEM

(71) Applicant: OCADO INNOVATION LIMITED, Hatfield, Hertfordshire (GB)

(72) Inventor: Clifton HOYLE, Hatfield, Hertfordshire (GB)

(73) Assignee: OCADO INNOVATION LIMITED, Hatfield, Hertfordshire (GB)

(21) Appl. No.: 18/881,014

(22) PCT Filed: Jul. 7, 2023
(86) PCT No.: PCT/EP2023/068902

§ 371 Date: Jan. 3, 2025

(30) Foreign Application Priority Data
Jul. 7, 2022 (GB) 2209958.4

(51) Int. Cl. B60L 53/53; B60L 53/16; B60L 53/55; B65G 1/04; H02J 7/34; H02J 9/06

(52) U.S. Cl. CPC B60L 53/53; B60L 53/16; B60L 53/55; B65G 1/0464; H02J 7/345; H02J 9/061; B60L 2200/26; B60L 2200/36

(57) ABSTRACT

A power bank is provided for charging a load handing device, the power bank including: an auxiliary rechargeable power source; and at least one power transfer device electrically coupled to the auxiliary rechargeable power source; wherein the at least one power transfer device is configured to electrically couple to a load handling device so as to transfer electrical power from the auxiliary rechargeable power source to the load handing device.

Buchanan

### FIELD OF INVENTION

The present invention relates to the field of storage and retrieval systems, more specifically to load handling devices operative on a track system of a grid framework structure, more specifically to the charging of power sources of load handling devices. The grid framework structure comprises a supporting framework structure upon which is mounted a track system that supports remotely operated load handling devices for handling storage containers stacked in the grid framework structure.

### BACKGROUND

The claimed invention is intended to provide improvements relating to charging power sources of load handling devices operating in automated storage and retrieval systems.

Load handling devices are typically powered by rechargeable power sources. The rechargeable power sources, once depleted, need to be recharged in order to permit the load handling device to continue operating. Charging can take a significant amount of time, and reduce the useful operational time of the load handling devices.

The charging time of the rechargeable power source can represent a significant downtime during which a load handling device remains inactive or inoperative. Where a number of load handling devices are operative in automated storage and retrieval system to fulfil customer orders within a given time slot, having one or more load handling devices remain idle for a significant amount of time has a detrimental impact on the ability of a fulfilment centre or distribution warehouse to fulfil orders in a timely manner. This is particularly the case where the load handling device contributes to a logistical system that provides home delivery of goods to a customer's premises upon receipt of an order of goods. Here, delivery information containing delivery addresses is used by online retailers such as Amazon and UK's Ocado to deliver goods to the customer's delivery address. To mitigate such a problem, online retailers such as UK's Ocado provide a buffer of load handling devices operative on the track system of the grid framework structure to cater for load handling devices that remain idle for charging. In an extreme case, time slots for the delivery of orders are extended to cater for this downtime.

Typically, load handling devices powered by lithium-ion batteries require a charge of 15 minutes for every 4 hours of discharge.

Typically, charge stations are provided on top of the track system at the edges of the grid framework structure. Charge stations permit load handling devices to be charged without leaving the track system, but have the disadvantage of taking up a significant amount of space that could otherwise be used for the storage of goods.

A storage and retrieval system is therefore needed in which charging does not take up a significant amount of space that could otherwise be used for storage, and in which the load handling devices can be charged quickly and easily without significant downtime.

### SUMMARY OF INVENTION

A power bank for charging a load handing device is provided, the power bank comprising:
an auxiliary rechargeable power source; and
at least one power transfer means electrically coupled to the auxiliary rechargeable power source;
wherein the at least one power transfer means is configured to electrically couple to a load handling device so as to transfer electrical power from the auxiliary rechargeable power source to the load handing device.

In another aspect, a load handling device is provided, comprising:
1) a main rechargeable power source;
2) a container-receiving space configured to receive a power bank as defined herein;
3) a container-lifting device comprising a container-engaging assembly configured to engage with the power bank, and a driving mechanism configured to lift the power bank into the container-receiving space,
   wherein the load handling device is configured to receive power from the power bank when the power bank is received within the container-receiving space of the load handling device. In this specification, the terms “container-lifting means” and “container-lifting device” are used interchangeably.

The container-receiving space may comprise a charge receiving element for receiving power from the power bank to charge the main rechargeable power source.

The container-engaging assembly may comprise one or more grippers, and the outer casing may be configured to be gripped by the grippers. The outer casing may be gripped, clamed, or grasped by the grippers.

In another aspect, a storage and retrieval system is provided comprising:
A) a grid framework structure comprising:
   i) a track system comprising a plurality of tracks arranged in a grid pattern;
   ii) a supporting framework structure supporting the track system; and
   iii) a plurality of stacks of storage containers arranged in a plurality of storage columns located below the track system;
B) a load handling device as defined herein, wherein the container-receiving space is further configured to receive a storage container, the container-engaging assembly is further configured to engage with a storage container, and the driving mechanism is further configured to lift the storage container from a stack of the plurality of stacks into the container-receiving space; wherein one or more of the storage containers in the stack is a power bank as defined herein

In another aspect, a storage and retrieval system is provided, comprising:
A) a grid framework structure comprising:
   i) a track system comprising a plurality of tracks arranged in a grid pattern;
   ii) a supporting framework structure supporting the track system; and
   iii) a plurality of stacks of storage containers arranged in a plurality of storage columns located below the track system;
B) a load handling device comprising:
   1) a main rechargeable power source;
   2) a container-receiving space for receiving a storage container, the container-receiving space comprising a charge receiving element for receiving power to charge the main rechargeable power source;
   3) container-lifting means comprising a container-engaging assembly configured for engaging with a storage container, and a driving mechanism for lifting the storage container from a stack of the plurality of stacks into the container-receiving space;
wherein one or more of the storage containers in the stack is a power bank comprising
   an auxiliary rechargeable power source;
   at least one power transfer means electrically coupled to the auxiliary rechargeable power source in the power bank, said at least one power transfer means being configured for electrically coupling with the charge receiving element of the load handling device so as to transfer electrical power from the auxiliary rechargeable power source in the power bank to the main rechargeable power source in the load handing device when the power bank is received within the container-receiving space of the load handling device.

An advantage of providing power banks that can charge the load handling devices is that no separate charging stations are required, thus saving space in the storage system. Charging stations are typically positioned at the edge of the track system and take up a lot of space-not only the space on top of the track system, but also the storage columns below the charging station, which are not available for storing items or products. The number and locations of the power banks can be chosen to be appropriate for the charging requirements of the load handling devices and the throughput of the storage and retrieval system.

The at least one power transfer means may comprise at least one electrical coupling element, the at least one electrical coupling element comprising a primary charge providing element configured to electrically couple the power bank to the charge receiving element on the load handling device in order to charge the main rechargeable power source in the load handling device.

The primary charge providing element on the power bank may comprise a primary charge providing contact and the charge receiving element on the load handling device may comprise a charge receiving contact, such that power is transferred by contact between the primary charge providing contact and the charge receiving contact. Alternatively, the primary charge providing element on the power bank may comprise a wireless charge transmitter and the primary charge providing element on the load handling device may comprise a wireless charge receiver, such that power is transferred wirelessly from the wireless charge transmitter to the wireless charge receiver. Power transfer by contact has the advantage of simplicity, whereas wireless power transfer has the advantage of not requiring contact, so there is no wear on the charge providing element on the power bank and the primary charge receiving element on the load handling device.

The power bank may comprise an outer casing configured to be received within the container-receiving space of the load handling device, the outer casing comprising one or more engagement features configured for engaging with the container-engaging assembly. The engagement features may comprise one or more apertures in the upper sides of the outer casing of the power bank, the apertures being configured to be engaged by the container-engaging assembly of the load handling device. The container-engaging assembly may comprise one or more grippers, and the outer casing may be configured to be clamped or grasped by the grippers. The outer casing may comprise one or more rims or lips and the container-engaging assembly may be configured to hook under the rims or lips. The outer casing may have the same dimensions or substantially the same dimensions as the storage containers.

The advantage of the features described in the above paragraph is that the load handling device may engage with the power bank in the same way as with a standard storage container. No modification is needed to the container engaging assembly in order to enable a power bank to be lifted into the container-receiving space and used to charge the load handling device. The only required modification to the load handling devices is the addition of the charge receiving element for electrically coupling with and receiving charge from a power bank. Therefore an existing storage and retrieval system may be easily retrofitted to work with power banks instead of external charging stations.

The outer casing may comprise a base, side walls, and an opening for receiving the auxiliary rechargeable power source. The auxiliary rechargeable power source in the power bank may be one or more supercapacitors, or an assembly of supercapacitors. The advantage of using supercapacitors as the auxiliary power source is speed of charging; enabling the load handling devices to charge rapidly reduces required downtime and increases the throughput of the storage and retrieval system. Using multiple supercapacitors achieves a higher power density and a higher energy storage capacity.

The assembly of supercapacitors may comprise a string of supercapacitor elements connected in series, with each element of the string comprising a plurality of supercapacitors connected in parallel. The particular arrangement of supercapacitor elements connected in parallel to form supercapacitor elements, which in turn are connected in series, is especially advantageous. Connecting supercapacitors in parallel enables the voltages of the supercapacitors to be more easily monitored, to ensure that none of them is allowed to operate at higher than rated voltage, which could damage the supercapacitor. Connecting supercapacitors in series increases the voltage.

Alternatively, the rechargeable power source in the power bank may be a rechargeable battery. Rechargeable batteries have the advantage of energy density, so a power bank may provide more charge to the load handling device.

The power bank may further comprise a voltage converter to convert the voltage from the auxiliary rechargeable power source in the power bank in order to charge the main rechargeable power source in the load handling device. The voltage converter may be a DCDC converter, for example a boost converter. A boost converter permits a greater proportion of the operating range of the auxiliary rechargeable power source to be used. This is especially relevant in the specific case where the auxiliary rechargeable power source in the power bank is a supercapacitor and the main rechargeable power source in the load handling device is a battery, because of the non-linear shape of the battery discharge curve. Without a DCDC converter, the battery would stop being charged once the supercapacitor voltage drops below the battery voltage.

One or more of the storage columns may comprise a charging surface comprising a charge providing element for charging a power bank when the charging surface is electrically coupled with the power bank. The charging surface is a base charging plate such that the power bank electrically couples with the base charging plate when the power bank is mounted on the base charging plate. Use of a base charging plate has the advantage of being easy to retrofit into an existing storage and retrieval system; since the base charging plate is at the base of a storage column, no modification to the structure of the storage column or grid framework structure is needed. In fact, the base charging plate still allows the storage column to be used as a standard storage column for storing storage containers, as well as for charging power banks. Flexibility in charging can be achieved by fitting more storage columns with base charging plates, so the storage columns can be used either for charging or for storage, depending on the requirements of the system at a given time. For example, during busy times when many orders are being fulfilled, storage columns provided with base charging plates can be used for storage of storage containers of goods or items to be picked for customer orders, thus increasing storage density and throughput, whereas during quiet times the same storage columns can be used for charging power banks.

Alternatively, the charging surface may be a bus bar extending upwardly along the storage column, such that the bus bar electrically couples with a side of the power bank. This arrangement has the advantage that any power bank in a stack of power banks can charge directly from the bus bar. A power bank at the top of a stack of power banks can thus charge directly from the bus bar, whereas in examples where the charging surface is a base charging plate the power bank at the top is charged by the power bank below in the stack (as will be described later), so charge is passed upwards from the base charging plate though each power bank in the stack of power banks to the power bank at the top.

The at least one electrical coupling element of the power bank may further comprise a primary charge receiving element configured to receive electrical power from the charge providing element of the charging surface. The charge receiving element is electrically coupled to the auxiliary power source in the power bank, and therefore enables the auxiliary rechargeable power source to be charged.

The at least one electrical coupling element of the power bank may further comprise a secondary charge providing element for electrically coupling with a vertically adjacent power bank above in a stack, and a secondary charge receiving element for electrically coupling with a vertically adjacent power bank below in the stack, such that, when arranged in a stack of power banks, power can be transferred from one power bank to another power bank in the stack.

The storage and retrieval system may comprise a plurality of power banks arranged in a stack, wherein their respective secondary charge providing and receiving elements electrically couple with each other in the stack to transfer charge from a power bank lower in the stack to a power bank higher up in the stack. This arrangement has the advantage of permitting charge to be transferred upwards through a stack in order to charge a power bank that is not directly electrically coupled to the charging surface. Thus, in examples where the charging surface is a base charging plate, the base charging plate can provide power to charge a whole stack of power banks rather than just the one power bank mounted on top of the base charging plate.

The secondary charge providing elements and secondary charge receiving elements may comprise secondary charge providing contacts and secondary charge receiving contacts respectively. Alternatively, the secondary charge providing elements and secondary charge receiving elements may comprise wireless charge transmitters and wireless charge receivers respectively. Power transfer by contact has the advantage of simplicity, whereas wireless power transfer has the advantage of not requiring contact, so there is no wear on the charge providing element on the power bank and the primary charge receiving element on the load handling device.

In another aspect, the invention provides a method for transferring power to a load handling device operative in a storage and retrieval system as defined herein, the method comprising the steps of:
a) moving the load handling device on the track system to a location above a stack comprising a power bank;
b) lifting the power bank into the container-receiving space of the load handling device using the container-lifting means, such that the at least one power transfer means electrically couples with the charge receiving element of the load handling device, so that power is transferred from the auxiliary power source in the power bank to the main rechargeable power source of the load handling device.

In another aspect, a method is provided for transferring power to a load handling device operative in a storage and retrieval system as defined herein, wherein the storage and retrieval system comprises a first load handling device and a second load handling device, the method comprising the steps of:
a) the first load handling device moving on the track system to a location above a stack comprising a power bank;
b) lifting the power bank into the container-receiving space of the first load handling device using the container-lifting means;
c) the first load handling device moving on the track system to a predetermined location;
d) the first load handling device returning the power bank to the stack below the target location in the grid framework structure;
e) the second load handling device lifting the power bank into the container-receiving space, such that power is transferred from the auxiliary power source in the power bank to the main rechargeable power source of the second load handling device.

The predetermined location could be a grid cell adjacent to or located close to the second load handling device. Advantageously, this method allows the second load handling device to be recharged without the need to travel to a power bank or charge station located remotely, e.g. on a different part of the track structure. For example, if the main power source of the second load handling device is partially depleted and only has enough charge to move a short distance, the second load handling device may be able to retrieve the power bank from the predetermined location and charge, rather than being stranded on the track system because it is not able to travel to another power bank or charge station.

The above methods may further comprise the step of the load handling device returning the power bank to a stack in the grid framework structure. The above methods may further comprise the step of the power bank being recharged in the stack of the grid framework structure.

### BRIEF DESCRIPTION OF THE DRAWINGS

Further features and aspects of the present invention will be apparent from the following detailed description of an illustrative embodiment made with reference to the drawings.

FIG. 1 schematically illustrates a grid framework structure and storage containers.

FIG. 2 schematically illustrates track on top of the grid framework structure illustrated in FIG. 1.

FIG. 3 schematically illustrates load handling devices on top of the grid framework structure illustrated in FIG. 1.

FIG. 4 schematically illustrates a single load handling device with container-lifting means in a lowered configuration.

FIG. 5 schematically illustrates cutaway views of a single load handling device with container-lifting means in a raised and a lowered configuration.

FIG. 6 is a perspective view of an example of a known container-lifting means.

FIG. 7 is a perspective side view of a known container-engaging assembly.

FIG. 8 is a perspective bottom view of a known container-engaging assembly.

FIG. 9 schematically illustrates a load handling device and a power bank.

FIG. 10 illustrates typical discharge curves for a battery and for a supercapacitor.

FIG. 11 schematically illustrates an assembly of supercapacitors comprising a string of supercapacitor elements connected in series, with each element of the string made up of several parallel capacitors.

FIG. 12 schematically illustrates a load handling device, container-lifting means, and a power bank.

FIG. 13 schematically illustrates a power bank with primary and secondary charge providing elements and charge receiving elements.

FIG. 14 schematically illustrates a power bank and a base charging plate.

FIG. 15 schematically illustrates a stack with a base charging plate and three power banks.

FIG. 16 is a flowchart illustrating a method of charging a main rechargeable power source in a load handling device.

FIG. 17 is a flowchart illustrating a method of a first load handling device bringing a power bank to a predetermined location, and then a second load handling device charging from the power bank.

### DETAILED DESCRIPTION

The following embodiments represent the applicant's preferred examples of how to implement the invention, but they are not necessarily the only examples of how that could be achieved.

### Grid Framework Structure

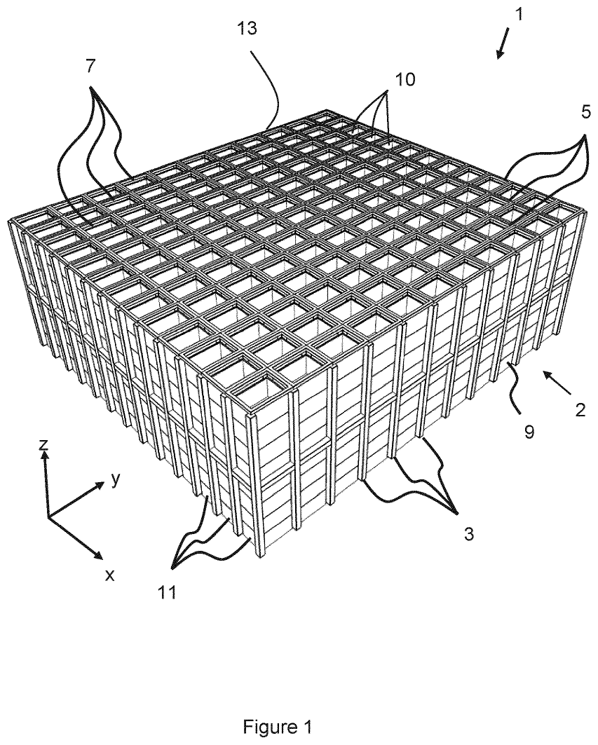

FIG. 1 illustrates a grid framework structure 1 comprising a supporting framework structure 2 supporting a track structure 13. The supporting framework structure 2 can take any suitable form. In the specific example illustrated in FIG. 1, the supporting framework structure 2 comprises a plurality of upright members 3 and horizontal members 5, 7 which are supported by the upright members 3. Upright members 3 may also be referred to as upright columns 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, storage containers 9 are arranged in stacks 11 beneath the grid cells defined by the grid pattern, one stack 11 of storage containers 9 per grid cell.

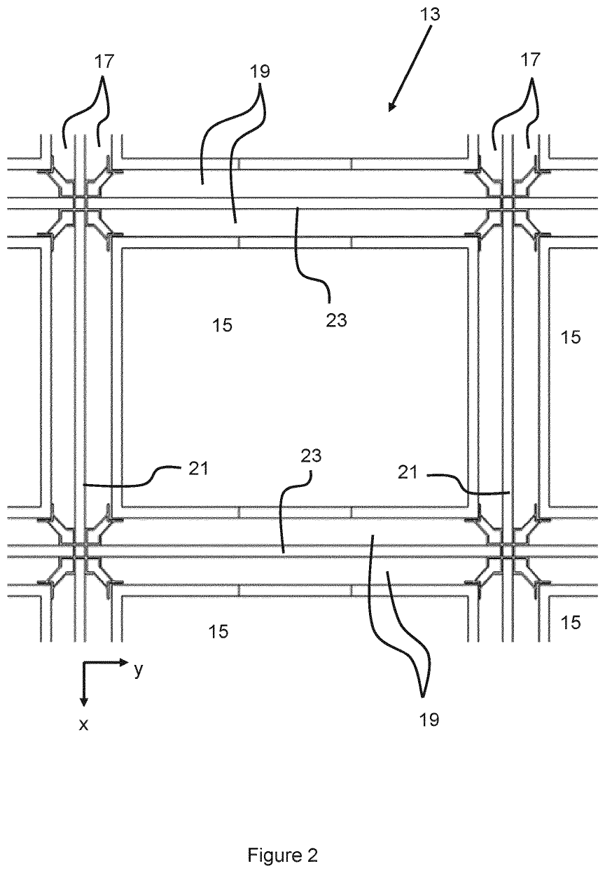

FIG. 2 shows a large-scale plan view of a section of track structure 13 forming part of the grid framework structure 1 illustrated in Error! Reference source not found. and located on top of the horizontal members 5, 7 of the grid framework structure 1 illustrated in Error! Reference source not found. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow storage containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

As an alternative to the supporting framework structure 2 as described with reference to FIG. 1, in other examples the support framework structure comprises a plurality of prefabricated modular panels arranged in a grid pattern, the detail of which is described briefly below and fully in the PCT application, WO2022034195A1, in the name of Ocado Innovation Ltd, and incorporated herein by reference. This grid framework structure 1 described in WO2022034195A1 addresses the problem of time and cost to assemble by providing a supporting framework structure 2 comprising a plurality of prefabricated modular panels arranged in a three dimensional grid pattern to define a plurality of grid cells. Each of the grid cells of the supporting framework structure 2 is sized to support two or more grid cells of the track system 13. The grid framework structure 1 is formed from fewer structural components yet still maintains the same structural integrity as the typical “stick-built” grid framework structure 1 described above, and is much faster and cheaper to build.

Any appropriate supporting framework structure 2 can be used in the current invention.

### Load Handling Device

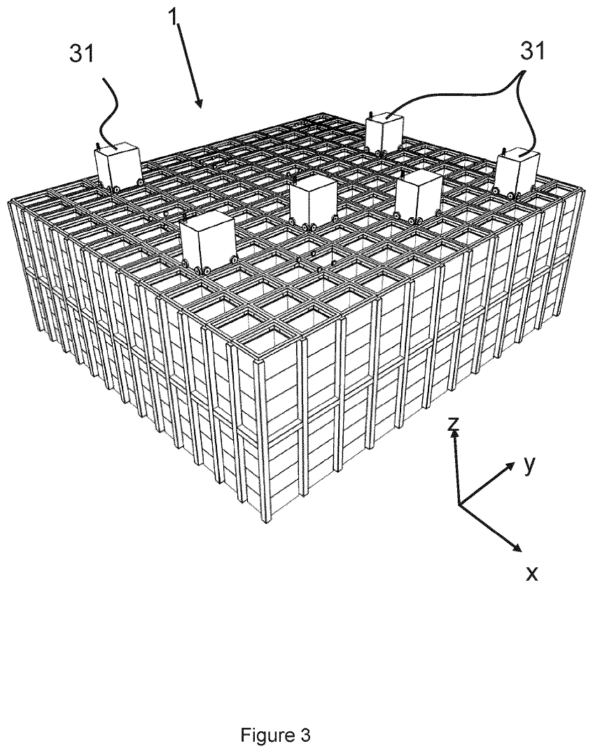

FIG. 3 shows a plurality of load handling devices 31 moving on top of the grid framework structure 1 illustrated in Error! Reference source not found. The load handling devices 31, which may also be referred to as robots 31 or bots 31, are provided with sets of wheels to engage with corresponding x- or y-direction tracks 17, 19 to enable the load handling devices 31 to travel across the track structure 13 and reach specific grid cells. The illustrated pairs of tracks 17, 19 separated by channels 21, 23 allow load handling devices 31 to occupy (or pass one another on) neighbouring grid cells without colliding with one another.

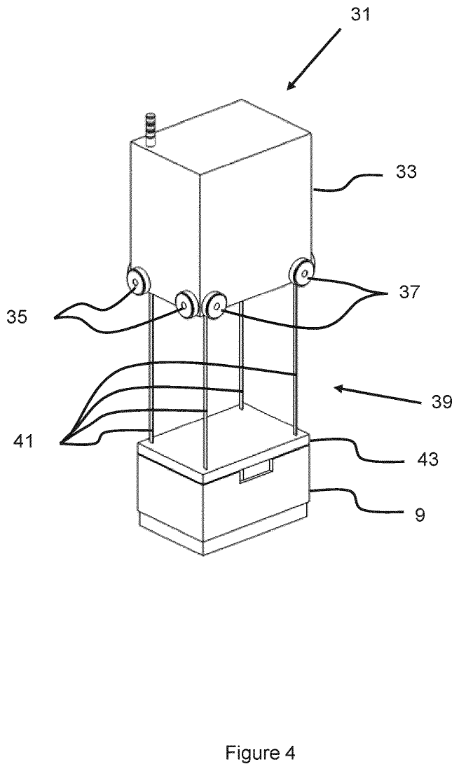

As illustrated in detail in FIG. 4, a load handling device 31 comprises a body 33 in or on which are mounted one or more components which enable the load handling device 31 to perform its intended functions. These functions may include moving across the grid framework structure 1 on the track structure 13 and raising or lowering containers 9 (e.g. from or to stacks 11) so that the load handling device 31 can retrieve or deposit containers 9 in specific locations defined by the grid pattern.

The load handling device 31 comprises a wheel assembly 34. The embodiment of the load handling device 31 illustrated in FIG. 4 comprises first and second sets of wheels 35, 37 which are mounted on the body 33 of the load handling device 31 and enable the load handling device 31 to move in the x- and y-directions along the tracks 17 and 19, respectively. In particular, two wheels 35 are provided on the shorter side of the load handling device 31 visible in Error! Reference source not found., and a further two wheels 35 are provided on the opposite shorter side of the load handling device 31 (side and further two wheels 35 not visible in Error! Reference source not found.). The wheels 35 engage with tracks 17 and are rotatably mounted on the body 33 of the load handling device 31 to allow the load handling device 31 to move along the tracks 17. Analogously, two wheels 37 are provided on the longer side of the bot 31 visible in Error! Reference source not found., and a further two wheels 37 are provided on the opposite longer side of the load handling device 31 (side and further two wheels 37 not visible in Error! Reference source not found.). The wheels 37 engage with tracks 19 and are rotatably mounted on the body 33 of the load handling device 31 to allow the load handling device 31 to move along the tracks 19.

The wheel assembly 34 of the load handing device 31 may be driven by a driving mechanism 38. The driving mechanism 38 may comprise one or more motors.

The load handling device 31 also comprises container-lifting means 39 configured to raise and lower storage containers 9. The illustrated container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with features of the storage containers 9. For instance, the storage containers 9 may be provided with one or more apertures in their upper sides with which the engaging means can engage. Alternatively or additionally, the engaging means may be configured to hook under the rims or lips of the storage containers 9, and/or to clamp or grasp the storage containers 9. The tapes 41 may be wound up or down to raise or lower the container-engaging assembly, as required. The container-lifting means 39 may be driven by a driving mechanism 38. The winding up or down of the tapes 41 of the container-lifting means 39 may be effected or controlled by the driving mechanism 38, which may comprise one or more motors or other means. The same driving mechanism 38 can be used to drive both the wheel assembly 34 and the container-lifting means 39, or separate driving mechanisms may be used for driving the wheel assembly and for driving the container-lifting means.

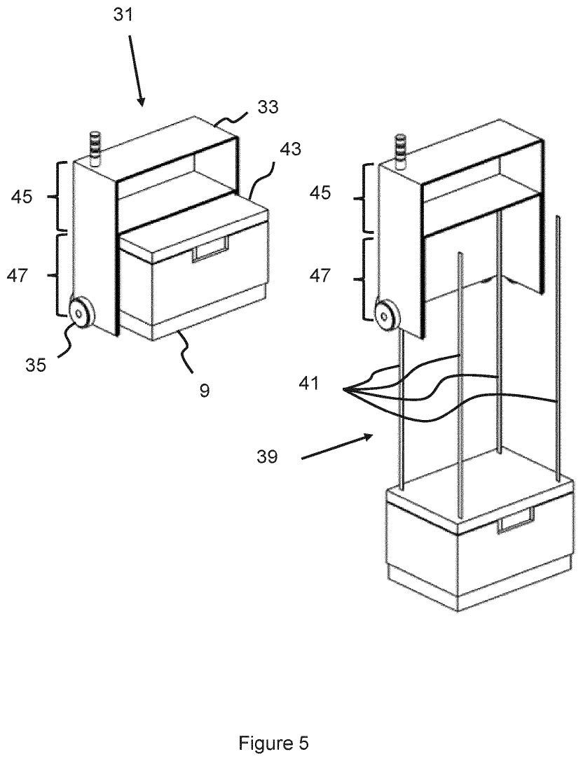

As can be seen in FIG. 5, the body 33 of the illustrated load handling device 31 has an upper portion 45 and a lower portion 47. The upper portion 45 is configured to house one or more operation components (not shown). The lower portion 47 is arranged beneath the upper portion 45. The lower portion 47 comprises a container-receiving space 49 or cavity for accommodating at least part of a storage container 9 that has been raised by the container-lifting means 39. The container-receiving space 49 is sized such that enough of a storage container 9 can fit inside the cavity to enable the load handling device 31 to move across the track structure 13 on top of grid framework structure 1 without the underside of the storage container 9 catching on the track structure 13 or another part of the grid framework structure 1. When the load handling device 31 has reached its intended destination, the container-lifting means 39 controls the tapes 41 to lower the container-engaging assembly 43 and the corresponding storage container 9 out of the container-receiving space 49 in the lower portion 47 and into the intended position. The intended position may be a stack 11 of storage containers 9 or an egress point of the grid framework structure 1 (or an ingress point of the grid framework structure 1 if the load handling device 31 has moved to collect a container 9 for grid framework in the grid framework structure 1). Although in the illustrated example the upper and lower portions 45, 47 are separated by a physical divider, in other embodiments, the upper and lower portions 45, 47 may not be physically divided by a specific component or part of the body 33 of the load handling device 31.

In some embodiments, the container-receiving space 49 of the load handling device 31 may not be within the body 33 of the bot 31. For example, in some embodiments, the container-receiving space 49 may be adjacent to the body 33 of the load handling device 31, e.g. in a cantilever arrangement with the weight of the body 33 of the load handling device 31 counterbalancing the weight of the container to be lifted. In such embodiments, a frame or arms of the container-lifting means 39 may protrude horizontally from the body 33 of the load handling device 31, and the tapes/reels 41 may be arranged at respective locations on the protruding frame/arms and configured to be raised and lowered from those locations to raise and lower a container into the container-receiving space 49 adjacent to the body 33. The height at which the frame/arms is/are mounted on and protrude(s) from the body 33 of the load handling device 31 may be chosen to provide a desired effect. For example, it may be preferable for the frame/arms to protrude at a high level on the body 33 of the load handling device 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the load handling device 31 lower when the load handling device 31 is loaded with a container.

The specific example of a load handling device illustrated in FIGS. 4 and 5 shows the load handling device 31 with a body 33 that is substantially box-shaped with four sidewalls and a top wall, with the components of the load handling device 31 housed within the body 33. In other examples the body 33 may comprise an open frame or skeleton structure, within or upon which components of the load handling device 31 are supported.

To enable the load handling device 31 to move on the different wheels 35, 37 in the first and second directions, the load handling device 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the grid framework structure 1.

The wheel-positioning mechanism may include one or more linear actuators, rotary components or other means for raising and lowering at least one set of wheels 35, 37 relative to the body 33 of the load handling device 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the load handling device 31 stays substantially at the same height and therefore the weight of the body 33 and the components mounted thereon does not need to be lifted and lowered by the wheel-positioning mechanism.

The driving mechanism(s) 38 used to drive the wheel assembly 34 and the container-lifting means 39 can be powered by a main rechargeable power source 53.

In some examples, the grid framework structure 1 may comprise one or more port columns or vertical chutes to facilitate the entry or removal of storage containers from the grid framework structure. A port column occupies one grid cell 14, bounded at the four corners by four of the vertical uprights 3 of the grid framework structure 1. Vertical guides may be provided to guide the storage container 9 in a vertical direction. To remove a storage container 9 from the grid framework structure 1, a load handling device 31 carrying a storage container 9 in its container-receiving space 49 travels to the grid cell 14 at the top of the port column and lowers the storage container 9 down until the storage container 9 reaches the bottom of the port column. The container-engaging assembly 43 of the load handling device 31 then disengages from the storage container 9 and is lifted back into the body 33 of the load handling device. The storage container 9 at the bottom of the port column can then be removed, for example by a conveyor belt or vehicle or human operative.

To bring a storage container 9 into the grid framework structure 1, the same operation is used in reverse. The storage container 9 is brought to the bottom of a port column (for example, by a conveyor belt or vehicle or human operative). A load handling device 31 travels to the grid cell at the top of the port column and lowers its container-engaging assembly 43 down the port column. The container-engaging assembly engages with the storage container, and the container-lifting means 39 lifts the storage container 9 up through the port column and into the container-receiving space 49 of the load handling device 31. The load handling device then travels on the track structure to take the storage container to its destination location in the grid framework structure.

### Container-Lifting Means

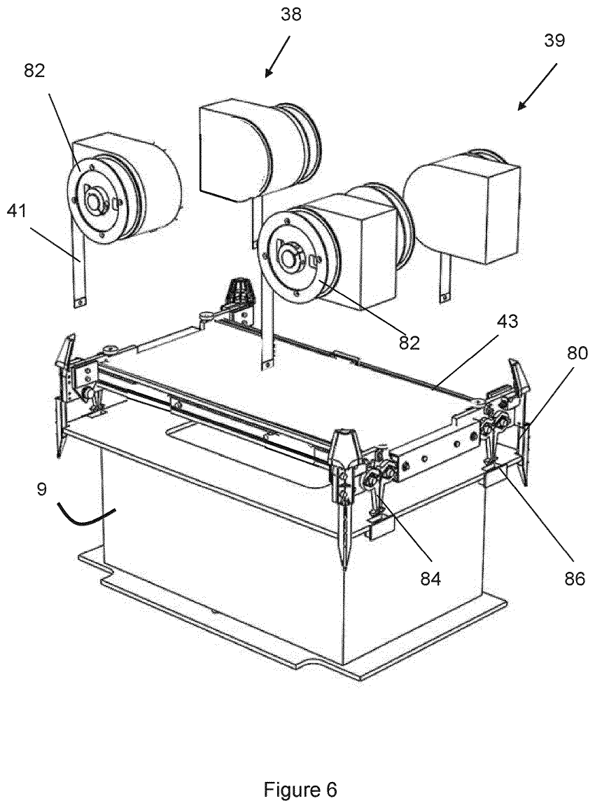

FIG. 6 shows a container lifting means 39 known in the art comprising a container-engaging assembly 43, otherwise known as a grabber device, for releasably connecting to a storage container 9 below, and a driving mechanism 38 to raise and lower the container-engaging assembly 43. The driving mechanism 38 can be the same driving mechanism used to drive both the wheel assembly 34 and the container-lifting means 39, or separate driving mechanisms may be used.

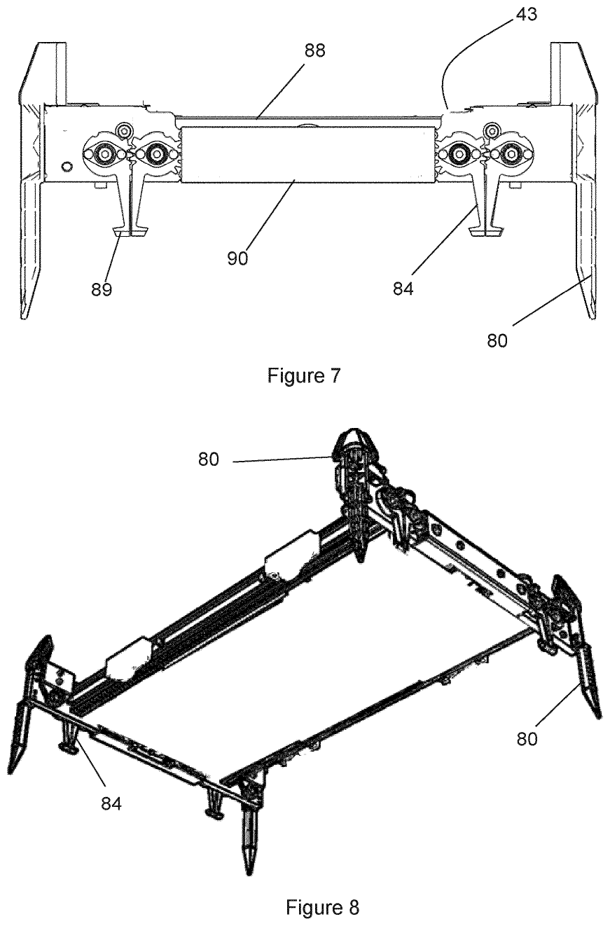

To raise and lower the container-engaging assembly 43, the driving mechanism 38 known in the art comprises a set of lifting tapes or bands 41 extending in a vertical direction between the container-engaging assembly 43 and the driving mechanism 38. For maximum stability and load capacity, commonly four lifting tapes 41 wound on separate spools 82 are shown extending between the driving mechanism 38 and at each corner of the container-engaging assembly 43. In an exemplary embodiment of the present invention, the container-engaging assembly 43 is formed as a frame having four corner sections, a top side 88 and a bottom side 90 (see FIG. 7). To grab a container 9, the container-engaging assembly 43 comprises four locating pins or guide pins 80 nearby or at each corner of the container-engaging assembly 43 which mate with corresponding cut outs or holes (not shown) formed at four corners of the container 9. Four gripper elements 84 arranged at the bottom side of the container-engaging assembly 43 to engage with the rim of the container 9 (see FIGS. 7 and 8). The locating pins 80 help to properly align the gripper elements 84 with corresponding holes or openings in the rim of the container 9. In the particular embodiment shown in FIG. 7, each of the gripper elements 84 comprises a pair of wings that are collapsible so as to be receivable in corresponding holes or openings 86 in the rim of the container 9 (see FIG. 6) and an open or enlarged configuration having a size greater than the holes 86 in the rim of the container 9 in at least one dimension so as to lock onto the container (see FIG. 6). The wings are actuated into the open and closed configuration by a suitable actuating mechanism coupled to a drive gear, but other actuating mechanisms for actuating the gripper elements known in the art are applicable in the present invention. In the specific example shown in FIG. 7, the head of at least one of the wings comprises a plurality of teeth that mesh with the drive gear such that when the gripper elements 84 are actuated by the actuating mechanism, rotation of the drive gear causes the pair of wings to rotate from a closed or collapsed configuration to an open enlarged configuration (FIGS. 7 and 8). When in the collapsed or closed configuration, the gripper elements 84 are sized to be receivable in corresponding holes 86 in the rim of the container 9 as shown in FIG. 6. The foot of each of the pair of wings comprises a stop 89, e.g. a boss, such that when received in a corresponding hole 86 in the rim of the container 9, the stop 89 engages with an underside of the rim when in an enlarged open configuration to lock onto the container when the container-engaging assembly 43 is winched upwards towards the container-receiving space 49 of the load handling device 31.

### Power Bank

The invention provides a power bank 51 configured for charging a load handling device 31. The power bank 51 comprises an outer casing 57 configured to be received within the container-receiving space 49 of the load handling device 31, and an auxiliary rechargeable power source 55 housed within the outer casing 57. One or more auxiliary rechargeable power sources 55 may be provided in the same power bank 51. The outer casing 57 comprises one or more engagement features. The engagement features of the power bank 51 are configured to engage with the engaging means of the container-engaging assembly 43 of the load handling device 31. The power bank 51 can therefore be lifted into the container-receiving space 49 of the load handling device 31, in a similar manner to a storage container 9 as discussed above.

The load handling device 31 comprises a main rechargeable power source 53, which may be a rechargeable battery or supercapacitor or any other suitable rechargeable power source 53. One or more main rechargeable power sources 53 may be provided in the same load handling device 31.

When the power bank 51 is lifted by the container-lifting means 39 into the container-receiving space 49 of the load handling device 31, the power bank 51 can charge the load handling device 31. More specifically, the auxiliary rechargeable power source 55 in the power bank 51 can recharge the main rechargeable power source 53 in the load handling device. The outer casing 57 comprises power transfer means configured to transfer electrical power from the auxiliary rechargeable power source 55 in the power bank 51 to the main rechargeable power source 53 in the load handing device 31 when the power bank 51 is received within the container-receiving space 49 of the load handling device 31.

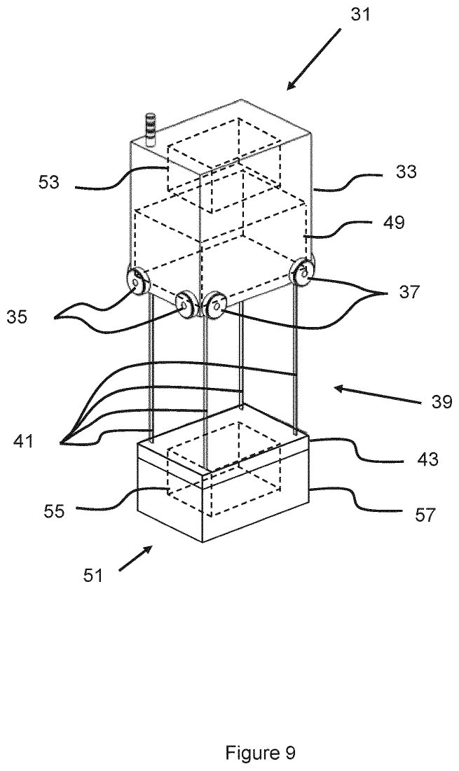

FIG. 9 illustrates a load handling device 31 and a power bank 51. The load handling device 31 comprises a main rechargeable power source 53 and a container-receiving space 49, which are illustrated in FIG. 9 with dotted lines. The load handling device 31 comprises a container-engaging means 39, which comprises a container-engaging assembly 43 configured to be raised or lowered by four tapes or bands 41. The power bank 51 comprises an outer casing 57 and an auxiliary rechargeable power source 55, the latter of which is illustrated in FIG. 9 with dotted lines. The container-engaging assembly 43 of the load handling device 31 is configured to engage with the power bank 51, specifically with the outer casing 57 of the power bank 51.

The power bank 51 may be a specialized storage container 9 adapted or configured for purpose of charging. The power bank 51 may be the same size as other storage containers 9 in the grid framework structure 1 used for storing products, and interface with the load handling device 31 in the same way.

It is advantageous for the voltage of the auxiliary rechargeable power source 55 of the power bank 51 to be lower than the voltage of the main rechargeable power source 53 in the load handling device 31, because this means there will be no reverse flow of power from the load handling device 31 to the power bank 51.

### Supercapacitors as Auxiliary Rechargeable Power Source

In some examples, the auxiliary rechargeable power source 55 in the power bank 51 may be a supercapacitor or an assembly of supercapacitors.

Supercapacitors tend to operate at low voltage, typically about 3 volts. To achieve a higher voltage, and therefore a higher energy storage capacity, multiple supercapacitors can be connected in series. For example, if the auxiliary rechargeable power source 55 has a rated voltage of 48 V, 16 supercapacitors of 3 V each can be arranged in series to achieve the same voltage as the auxiliary rechargeable power source 55.

Alternatively, a DCDC converter can be used to convert the voltage of the assembly of supercapacitors to an appropriate voltage to charge the auxiliary rechargeable power source 55. For example, a boost converter can be used to boost the supercapacitor voltage, running in constant current mode. Constant current mode is suitable to use for fast charging.

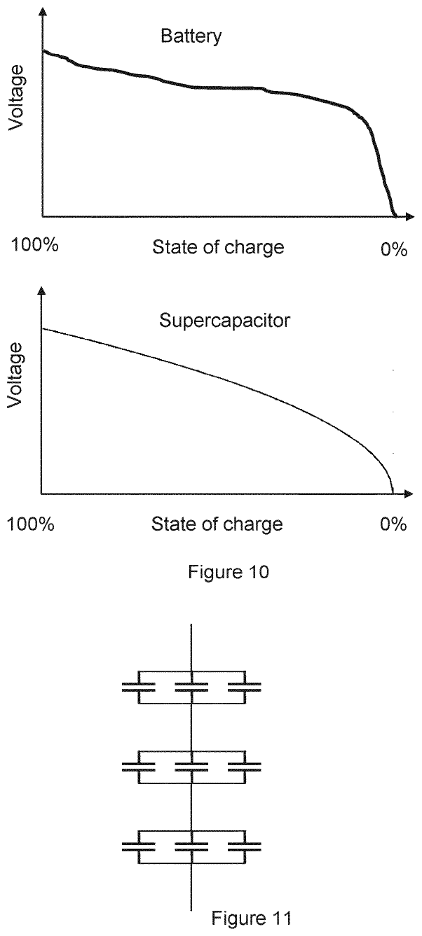

As well as the advantage of lower voltage in the power bank 51 preventing reverse flow of power, in the specific example where the auxiliary rechargeable power source 55 in the power bank 51 is a supercapacitor or an assembly of supercapacitors and the main rechargeable power source 53 in the load handling device 31 is a battery, lower voltage is preferable because of the relative shapes of the discharge curves. FIG. 10 illustrates typical discharge curves for a battery and for a supercapacitor. The discharge curve for a supercapacitor is linear for constant current load and a square root relationship to state of charge, and the discharge curve for a battery is non-linear with a relatively flat portion followed by a steeper drop. When the load handling device is being charged by a power bank 51, the supercapacitor in the power bank 51 is discharging (supercapacitor voltage decreasing) as the battery in the load handling device 31 is charging (battery voltage increasing). When the supercapacitor voltage drops below the battery voltage, charging stops. Boosting the voltage of the supercapacitor enables a greater portion of the operating range of the supercapacitor to be used.

The controller of the DCDC boost converter control sets a current and voltage target (for example, the voltage target could be the nominal voltage of the rechargeable power source 55 in the load handling device 31). As the supercapacitor discharges and its voltage drops, the current increases. The limiting factor on how low the supercapacitor voltage can drop is the current through the supercapacitor; too high a current can causes problems with overheating. In practice the boost control tries to meet the target voltage, but once a low supercapacitor voltage is reached is constrained by the current. A much larger proportion of the supercapacitor's operating range is usable with a DCDC converter.

To achieve a higher power density and a higher energy storage capacity, multiple supercapacitors can be connected in parallel. The main advantage of connecting in parallel is that it is easier to monitor the voltages of the supercapacitors to ensure that none of them are allowed to operate at higher than rated voltage—when connected in parallel, the voltage only needs to be monitored at two positions, whereas when connected in series the voltage needs to be monitored at every point between consecutive supercapacitors in the chain.

The supercapacitor voltage needs to be carefully managed to ensure that the voltages stay balanced—if one supercapacitor were to operate above its rated voltage, that supercapacitor could easily be damaged.

An assembly of supercapacitors can therefore comprise supercapacitors in series, or in parallel, or both. For example, an assembly of supercapacitors may comprise a string of supercapacitor elements connected in series, with each element of the string made up of several parallel capacitors. This arrangement combines the advantages of increased voltage and ease of monitoring the voltage across each element of the string to ensure that no supercapacitor is permitted to operate above its rated voltage. Such an arrangement is illustrated in FIG. 11.

The term “supercapacitor” is used broadly to encompass any capacitor technology. Examples include capacitors, supercapacitors, ultracapacitors, lithium capacitors, electrochemical double layer capacitors, electric double layer capacitors, pseudocapacitors, or hybrid capacitors.

### Battery as Auxiliary Rechargeable Power Source

In other examples, the auxiliary rechargeable power source 55 in the power bank 51 may be a rechargeable battery. Batteries have the advantage of high energy density, so could be used to fully recharge the load handling device 31 from a low charge level to a fully charged state, using one power bank 51.

Examples of rechargeable batteries include but are not limited to lithium ion batteries, lithium-ion polymer batteries, lithium-air batteries, lithium-iron batteries, lithium-iron-phosphate batteries, lead-acid batteries, nickel-cadmium batteries, nickel-metal hydride batteries, nickel-zinc batteries, sodium-ion batteries, sodium-air batteries, thin film batteries, smart battery carbon foam-based lead acid batteries.

Other rechargeable power source technologies are applicable in the current invention. Although the specific examples of rechargeable batteries and supercapacitors are described, any suitable rechargeable power source can be used.

Similarly, the main rechargeable power source 53 in the load handling device 31 can be a rechargeable battery, a supercapacitor, or any other suitable rechargeable power source.

### Charging the Load Handling Device

The power transfer means 59 of the power bank 51 is configured to transfer electrical power from the power bank 51 to the load handling device 31 in order to charge the load handling device 31. This can be achieved by at least one coupling element. In some examples, the at least one coupling element comprises a primary charge providing element 62 on the power bank 51. The primary charge providing element 62 is configured to transfer electrical power to a charge receiving element 65 on the load handling device 31 in order to charge the main rechargeable power source 53 in the load handling device 31. The primary charge providing element 62 and the charge receiving element 65 can take any appropriate form so long as electrical power can be transmitted-for example, power could be transferred by contact or wirelessly.

In cases where power is transferred by contact, the primary charge providing element 62 on the power bank 51 comprises a primary charge providing contact 62 and the charge receiving element 65 on the load handling device 31 comprises a charge receiving contact 65, such that power is transferred by contact between the primary charge providing contact 62 and the charge receiving contact 65.

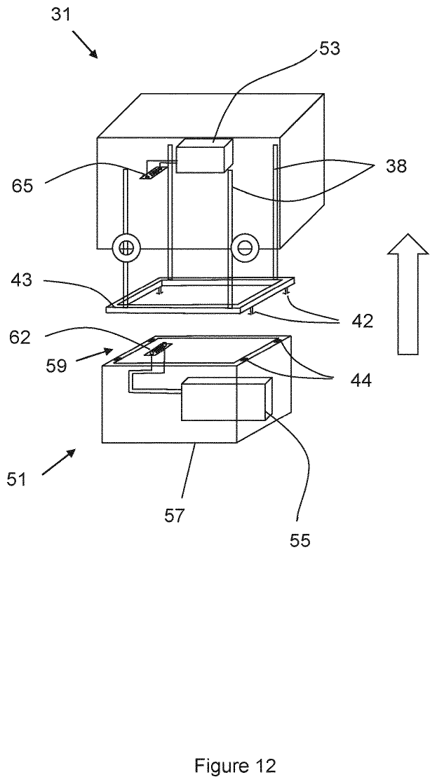

FIG. 12 illustrates an example of a load handling device 31 and a power bank 51 where power is transferred by contact. The load handling device 31 comprises a main rechargeable power source 53 electrically connected to a charge receiving contact 65, and a container-engaging assembly 43 which can be raised or lowered by four tapes 38. The container-engaging assembly 43 comprises engaging means 42 for engaging with the power bank 51.

The power bank 51 comprises an auxiliary rechargeable power source 55 electrically connected to a primary charge providing contact 62, and an outer casing 57. The outer casing 57 comprises engagement features 44 for engaging with the engaging means 42 of the load handling device 31.

In order to charge the load handling device 31, the container-engaging assembly 43 is lowered by the four tapes 38. The engaging means 42 on the container-engaging assembly 43 engage with the engagement features 44 of the power bank 51. Once engaged, the power bank 51 is lifted into the container-receiving space 49 of the load handling device 31. Once the power bank 51 is lifted into the container-receiving space 49, the primary charge providing contact 62 contacts the charge receiving contact 65 of the load handling device 31, and power is transferred from the power bank 51 to the load handling device 31. Power is transferred from the main rechargeable power source 55 of the power bank 51 to the rechargeable power source 53 of the load handling device 31 via the primary charge providing contact 62 of the power bank 51 and the charge receiving contact 65 of the load handling device 31.

In some examples, control signals can be transferred between the load handling device 31 and the power bank 51. These signals can be transferred using the same primary charge providing contact 62 and charge receiving contact 65, or using a different contact or connector. If using a different connector, a connect block can be provided on both the load handling device and the power bank, the connect block on the power bank 51 comprising the primary charge providing contact 62 and a control contact or connector, and the connect block on the load handling device 31 comprising the charge receiving contact 65 and a control contact or connector. Alternatively, control signals can be transmitted wirelessly.

When the primary charge providing element 62 and the charge receiving element 65 comprise a primary charge providing contact 62 and a charge receiving contact 65 respectively, condition monitoring of the contacts may be beneficial. Auxiliary or signal pins can be used for primary contact condition monitoring, to monitor how charge is transferred and to stop the charging if any potential issues are detected, for example issues with wiring or overheating.

In cases where power is transferred wirelessly, the primary charge providing element 62 on the power bank 51 comprises a wireless charge transmitter and the charge receiving element 65 on the load handling device 31 comprises a wireless charge receiver, such that power is transferred wirelessly from the wireless charge transmitter to the wireless charge receiver. Control signals can also be transferred wirelessly. For example, Near Field Communication (NFC) can be used in conjunction with wireless charging.

### Charging Via a Stack in a Storage Column

When positioned in a stack 11 in the grid framework structure 1, a power bank 51 can be recharged from another power bank 51 below it in the stack 11. The power bank 51 at the bottom of the stack 11 can be recharged from a base charging plate 67 located at the bottom of the stack 11.

The base charging plate 67 provides a scalable solution. A base charging plate 67 can be used to charge a single power bank 51, or a whole stack of power banks 51. An advantage of charging a stack of power banks 51 at the same time is spatial efficiency: a whole stack of power banks 51 can be recharged at the same time, while occupying the footprint of only one grid space or grid cell 14. This gives much better efficiency than using charging stations on the track system 13: with a charging station, only one load handling device 31 can be charged at once, and the space underneath the grid cell 14 where the charge station is located is effectively “dead space”, because the storage column 10 underneath the grid cell 14 is inaccessible.

Dedicated charge stacks can be used for power banks 51, with a base charging plates 67 permanently fixed to the ground at the bottom of the stack 11. Alternatively, to allow more flexibility, stacks 11 can be dual-purpose, and usable either for charging or for storage. In some examples the base charging plates 67 can be moveable, so that a storage column 10 can either be used as a dedicated charging column for a stack of power banks 51 (with base charging plate 67 present), or the storage column 10 can be used for storage containers 9 with products to be stored with the base charging plate 67 removed. In other examples, when the stack 11 is not required to be used for charging, the stack 11 can be used for storage with storage containers 9 stacked on top of the base charging plate 67.

The auxiliary rechargeable power source 55 in the power bank 51 may be constantly replenished when in the stack 11.

In order to facilitate charging in a stack 11, the power transfer means 59 performs the function of allowing the power bank 51 to receive power, as well as allowing the power bank 51 to provide power to a load handling device 31. The power transfer means 59 comprises at least one electrical coupling element, and in addition to the at least one electrical coupling element comprising a primary charge providing element 61, further electrical coupling elements may be provided to facilitate the power bank 51 receiving power from a base charging plate 67, and/or providing power to and/or receiving power from another power bank 51.

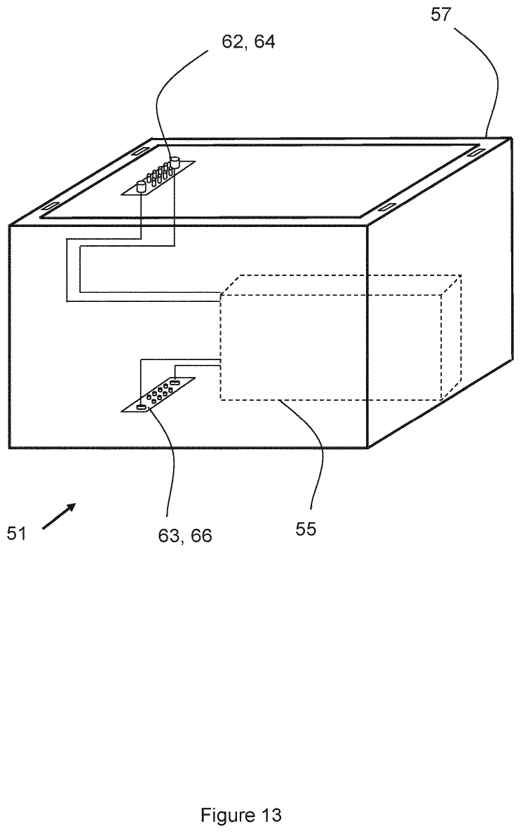

FIG. 13 illustrates an example of a power bank 51 configured to be charged in a stack 11. As in the example of FIG. 12, the power bank 51 comprises an auxiliary rechargeable power source 55 electrically connected to a primary charge providing contact 62, and an outer casing 57. The power bank 51 further comprises a primary charge receiving contact 63, through which the power bank 51 can receive charge from a base charging plate 67.

In addition to the primary charge providing contact 62 for charging a load handing device 31, and the primary charge receiving contact 63 for receive charge from a base charging plate 67, the power bank 51 comprises a secondary charge providing contact 64 and a secondary charge receiving contact 66 for providing charge to and receiving charge from another power bank 51 in a stack 11. In some examples the primary 62, 63 and secondary 64, 66 charge providing/receiving contacts can be separate elements, and in other examples the primary 62, 63 and secondary 64, 66 charge providing/receiving contacts can be the same elements. In the example illustrated in

FIG. 13, the primary charge providing contact 62 and the secondary charge providing contact 64 are the same, i.e. one charge providing contact fulfils both the primary function of charging a load handling device 31 and the secondary function of charging another power bank 51 above in the stack. Similarly, the primary charge receiving contact 63 and the secondary charge receiving contact 66 are the same, i.e. one charge receiving contact fulfils both the primary function of receiving charge from the base charging plate 67 and the secondary function of receiving charge from another power bank 51 below in the stack.

In the illustrated example, the primary and secondary charge providing contact 62, 64 is located on the top of the upper surface of the power bank 51, and the primary and secondary charge receiving contact 63, 66 is located on the underside of the bottom surface of the power bank 51.

When the power bank 51 is recharging in a stack 11, the secondary charge providing contact 64 engages with the secondary charge receiving contact 66 of a power bank 51 directly above (vertically adjacent to) the power bank 51 in the stack 11, and the secondary charge receiving contact 66 of the power bank 51 engages with the secondary charge providing contact 64 of another power bank 51 directly below (vertically adjacent to) the power bank 51 in the stack 11. Thus the power bank 51 can simultaneously receive power from a power bank 51 below, and provide power to a power bank 51 above in the stack 11.

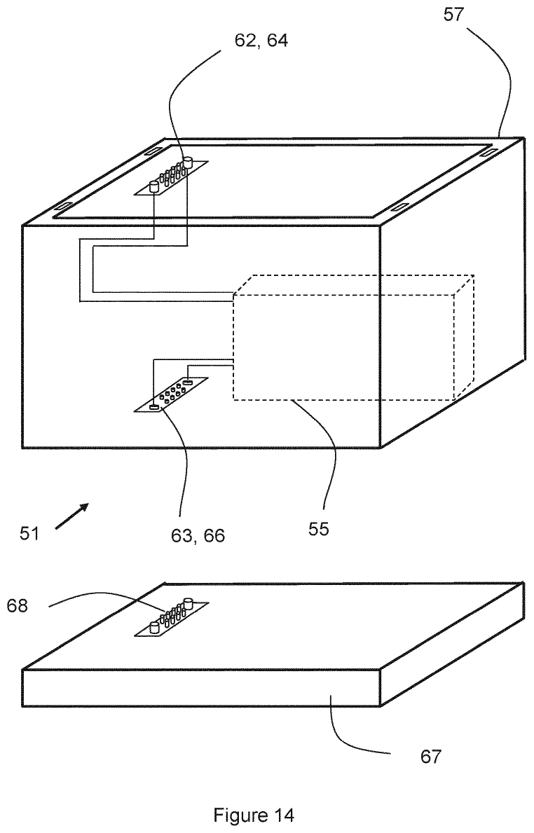

FIG. 14 illustrates an example of a power bank 51 and a base charging plate 67. The base charging plate 67 comprises a charge providing contact 68, which is configured to engage with the primary charge receiving contact 63 of the power bank 51. The charge providing contact 68 of the base charging plate 67 is located on the top of the upper surface of the base charging plate 67, so that the charge providing contact 68 of the base charging plate 67 aligns with and engages with the primary charge receiving contact 63 located on the underside of the bottom surface of the power bank 51.

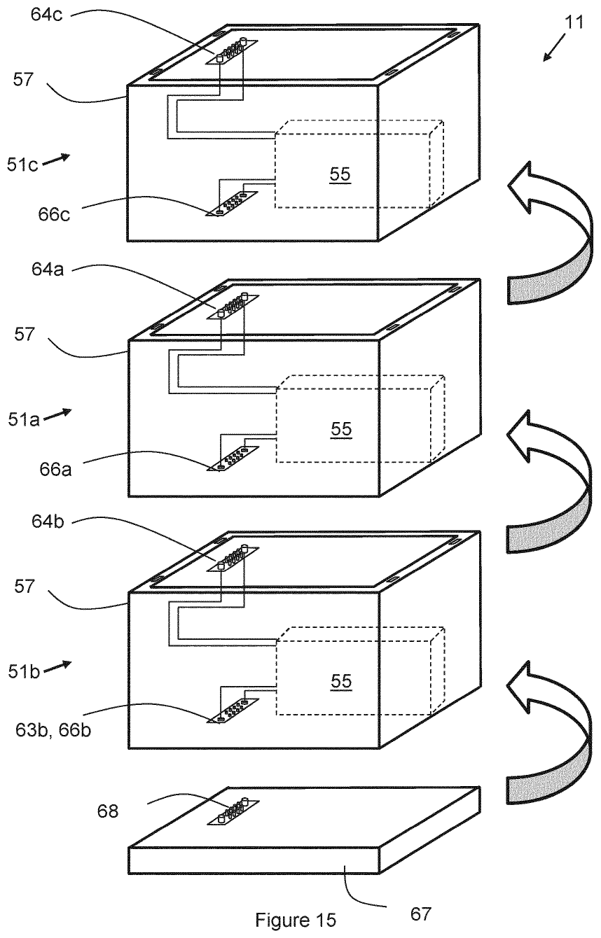

FIG. 15 illustrates an example of a stack 11 with a base charging plate 67 and three power banks 51. In the following description, the three power banks 51 are defined as a first power bank 51a, a second power bank 51b, and a third power bank 51c. The references a, b, and c will be used to denote the first, second, and third power banks 51 respectively, and components thereof.

The first power bank 51a is located in the centre of the stack 11. The second power bank 51b is at the bottom of the stack 11 directly below the first power bank 51a. The third power bank 51c is at the top of the stack 11 directly above the first power bank 51a. Each of the first, second, and third power banks 51a, 51b, 51c comprise a secondary charge providing contact 64a, 64b, 64c located on the upper surface of the respective power bank 51a, 51b, 51c, and a secondary charge receiving contact 66a, 66b, 66c located on the underside of the lower surface of the respective power bank 51a, 51b, 51c.

The first power bank 51a receives power from the second power bank 51b directly below the first power bank 51a in the stack 11. More specifically, the secondary charge receiving contact 66a of the first power bank 51a receives power from the secondary charge providing contact 64b of the second power bank 51b.

The first power bank 51a transfers power to the third power bank 51c directly above the first power bank 51a in the stack 11. More specifically, the secondary charge providing contact 64a of the first power bank 51a transfers power to the secondary charge receiving contact 66c of the third power bank 51c. Thus the first power bank 51a, being in the centre of the stack 11, simultaneously receives power from the second power bank 51b and provides power to the third power bank 51c. Power is transferred upwards through the stack of power banks 51.

The second power bank 51b, which is at the bottom to the stack 11, receives power from the base charging plate 67. More specifically, the primary charge receiving contact 63b of the second power bank 51b receives power from the charge providing contact 68 of the base charging plate 67. In the illustrated example, the primary charge receiving contact 63b and the secondary charge receiving contact 66b of the second power bank are the same contact.

The arrows on FIG. 15 indicate the direction of power transfer. Power is transferred from the base charging plate 67 upwards through each of the power banks 51 in turn, each power bank 51 in the stack 11 receiving power from below and transferring power up to the power bank 51 above in the stack 11.

In the example illustrated in FIGS. 12 to 15, the charge providing contact 68 of the base charging plate 67 is of the same design as the primary and secondary charge providing contact 64, 66 of the power bank 51, and the primary and secondary charge receiving contact 63, 66 of the power bank 51 is of the same design as the charge receiving contact 65 of the load handling device 31. The electrical contacts are horizontally aligned when the power banks 51 are in the stack 11. The power banks 51 are therefore interchangeable, and can receive power from either from the base charging plate 67 or from another power bank 51 below in the stack 11, and can provide charge either to a load handling device 31 or to another power bank 51 above in the stack 11.

In other examples, the power bank 51 could be provided with a separate primary charge providing contact 62 for charging a load handling device 31 and a separate secondary charge providing contact 64 for charging another power bank 51, rather than a single charge providing contact that fulfils both functions.

In the example illustrated in FIGS. 12 to 15, power is transferred by contact between a charge providing contact and a charge receiving contact. In other examples, the power transfer means 59 can comprise other means of transferring power, for example by wireless power transfer.

### Location and Distribution of Charging Columns

In large storage systems, multiple dedicated charging stacks may be needed to ensure that sufficient power banks 51 are provided to keep all of the load handling devices 31 charged without also needing external chargers.

The charging stacks may be distributed evenly through the grid framework structure 1 to ensure that load handling devices 31 can be anywhere on the track system 13 and never be too far away from a charging column. Alternatively, charging stacks may be located near to the port columns in order to reduce travelling time of the load handling devices 31. Alternatively, charging stacks may be located further away from the port columns, so that load handling devices 31 that are charging can do so without obstructing the path of load handling devices 31 that are fulfilling customer orders, and/or to allow the storage columns 10 that are closer to the port columns to be used for storage of stacks of containers 9, in order to use the available space efficiently and minimize the distance between the port column and the storage container 9 to be picked by the load handling devices 31. Alternatively, charging stacks may be located at the edges of the grid framework structure 1 in order that the base charging plates 67 of the charging stacks can be easily reached for maintenance. The location and distribution of charging stacks through the grid framework structure 1 can be any of the above, or any combination of the above. The best location and distribution for charging stacks may depend on the size and layout of the grid framework structure 1, the number of load handling devices 31, and the rate of throughput of customer orders.

### Bypass Charging

In some examples, it is possible to bypass the charging method described above where power is transferred up though the stack of power banks 51 in a stack 11 by each power bank 51 charging the power bank 51 above it in the stack. This enables a power bank 51 in a stack 11 but not at the bottom of the stack 11 to be charged directly from the base charging plate 67, rather than charged from the power bank 51 directly below in the stack 11. This can be useful if, for example, the power bank 51 at the top of the stack 11 needs to be charged first, e.g. if a load handling device 31 is in imminent need of charging and it is undesirable to wait until the whole stack of power banks 51 in the stack 11 is fully charged.

Bypass charging can work through the same electrical contacts as described above, in which power is transferred to the secondary charge receiving element 66 of a power bank 51 from the charge providing element 68 on the base charging panel 67 or the secondary charge providing element 64 on another power bank 51 directly below in the stack 11. Each power bank 51 may be provided with a bypass mechanism, which directs power from the primary 63 or secondary 66 charge receiving element to the secondary charge providing element 64 while bypassing the rechargeable power source 55 in the power bank 51. Thus, power can be transferred from the base charging plate 67 at the bottom of the stack 11 to the power bank 51 through a chain of the charge receiving elements 63, 66 and secondary charge providing elements 64 of all of the power banks 51 in the stack, to the power bank 51 at the top of the stack. The rechargeable power source 55 in the power bank 51 at the top of the stack is charged, without the rechargeable power sources 55 of all of the other power banks 51 below in the stack needing to be charged first.

In some examples, the bypass mechanism in a power bank 51 may divide the current received from the base charging plate 67 or from the power bank 51 below in the stack 11, so that part of the current is used to charge the auxiliary rechargeable power source 55 in the power bank 51, and the remainder of the current is transferred to a power bank 51 above in the stack 11. Thus a power bank 51 can simultaneously charge and pass power upwards in the stack 11.

### Bus Bar Charging

Optionally, a bus bar may be provided for charging the power banks 51 in a charging stack, as an alternative to or in addition to the base charging plates 67. Optionally, the bus bar can be integrated into an upright member 3 of the grid framework structure 1. Every power bank 51 in the stack 11 can be in contact with the bus bar, so any power bank 51 can be charged directly from the bus bar, irrespective of the power bank's position in the stack 11. A control system is provided to control how much current each power bank 51 draws from the bus bar. The bus bar has the advantage of total flexibility in charging; any power bank 51 at any position in the dedicated charging stack 61 can be charged.

The bus bar may be for rapid charging, using a higher current than charging through the base charging plate 67 or charging from another power bank 51 as described above. Rapid charging may be provided by a buck converter in constant current mode, converting a higher voltage supply at the bus bar of the stack 11 to a lower voltage for charging the power bank 51.

The power banks 51 may be provided with a separate electrical contact to facilitate charging from the bus bar, located on the side of the power banks 51.

Rapid charging is particularly effective in cases where the auxiliary rechargeable power source 55 in the power bank 51 is a supercapacitor, because supercapacitors can accept a higher current than rechargeable batteries.

### Control System

One or more control systems may be provided, to carry out functions including but not limited to controlling the movement of load handling devices 31 on the track system 13, tracking charge levels of the main rechargeable power sources 53 in load handling devices 31, tracking the charge levels of the auxiliary rechargeable power sources 55 in power banks 51, identifying where on the track system 13 the load handling devices 31 should go while charging, controlling when and how to remove power banks 51 from the grid framework structure 1, controlling the bypass mechanism of the power banks 51, and controlling how much current a power bank 51 can draw from a bus bar. These operations can be carried out by the same control system or by different control systems.

In order to ensure that the load handling devices 31 are charged when necessary, the control system can monitor the state of charge of the load handling devices 31 and the power banks 51. This can be achieved in several different ways. For example, the load handling devices 31 and power banks 51 can send a signal to the control system indicating the state of charge.

Alternatively, the control system can ensure that a given power bank 51 is allowed to recharge for a predetermined length of time before being used again for charging a load handling device 31. Power banks 51 that are not fully charged will still be able to deliver a partial charge to a load handling device 31. If a load handling device 31 is not fully charged after charging from a power bank 51, the load handling device 31 can communicate to the control system that further charging is required, and the control system can then direct the load handling device 31 to pick up another power bank 51.

Alternatively, power banks 51 could communicate their state of charge to the control system via the base charging plate 67, either directly or via other power banks 51 in a stack 11 above the base charging plate 67. The control system can choose the power bank 51 with the highest state of charge, or the power bank 51 that has been charging for the longest time, to be used for charging the next load handling device 31 that requires charging.

The control system may also monitor the condition of the electrical contacts, for example to detect issues with wiring or overheating.

### Size, Capacity, and Types of Storage Containers

The power bank 51 can be the same height as the storage containers 9. Alternatively, the power bank 51 can be a shorter height than the storage containers 9, in which case a greater number of power banks 51 can fit in a stack 11. For example, if power banks 51 were half the height of storage containers 9, twice as many power banks 51 could fit in a stack 11 as storage containers 9 in a stack 11.

To provide more flexibility with charging, the system may be provided with power banks 51 with different energy storage capacity. For example, two capacities of power banks 51 may be provided: a first capacity of power bank 51 with a higher storage capacity, and a second capacity of power bank 51 with a lower storage capacity. The two capacities of power banks 51 can be stored in different stacks 11, or together in the same stack 11. The first capacity of power bank 51 can be used when the load handling device 31 requires a full charge. The second capacity of power bank 51 is used for lower charging requirements, e.g. when a load handling device 31 needs a partial charge, or for shorter charging opportunities, e.g. when a load handling device 31 has only a short time for charging before being required for its next operation. The main advantage of providing different capacities of power bank 51 with different energy storage capacities is flexibility in charging: whether a load handling device 31 requires a partial charge or a full charge, there will be a power bank 51 available to deliver an appropriate amount of charge, and the full capacity of the power bank 51 can be used.

In some examples, the two capacities of power bank 51 have different dimensions. The first capacity of power bank 51 has the same dimensions as a standard storage container 9, and the second capacity of power bank 51 is half the height of a standard storage container 9. The second capacity of power bank 51 contains fewer auxiliary rechargeable power sources 55 than the first capacity, therefore requires less space for packaging the auxiliary rechargeable power sources 55 and other components. Since shorter power banks 51 take up less space, more of them can be stored in a stack 11. This allows the possibility of providing more power banks 51 than necessary for the number of load handling devices 31 in the system, therefore allowing more load handling devices 31 to charge during quiet times.

Alternatively or additionally, power banks 51 of different energy storage types may be provided. For example, a first type power bank 51 may be provided with supercapacitors as a main rechargeable power source 55, which have the advantage of high power density and a fast charge rate. A second type power bank 51 may be provided with one or more batteries as a main rechargeable power source 55, which have the advantage of higher energy storage capacity. This gives additional flexibility in charging: if a load handling device 31 needs a quick charge it can pick up a first type power bank 51 and charge quickly from the supercapacitor power source, and when a load handling device 31 requires a slower charge or a greater charge it can pick up a second type power bank 51 and charge more slowly from the battery power source.

It will be appreciated that many different combinations of different capacities and sizes and types and charging speeds of power banks 51 are possible. All of the power banks 51 interface to the load handling device 31 in the same way as a standard storage container 9, and all of the power banks 51 interface to each other and to the base charging plate 67 in the same way.

### Ambient Temperature

A storage and retrieval system may have different sections operating at different temperatures, in order to store products with different temperature requirements. For example, a storage and retrieval system may have a section of goods at ambient temperature, and a section for chilled goods at a lower temperature, and a section for frozen goods.

In examples where the auxiliary rechargeable power source 55 in the power bank 51 is a battery and the ambient temperature is low, there are further considerations. For example, if a battery is cold it needs to be warmed up by slow charging until the battery cells reach a certain positive temperature, after which the battery cells can be charged more rapidly. Therefore in areas of lower ambient temperature, the load handling devices 31 are likely to hold the power banks 51 for a longer period of time. In low temperature areas, therefore a higher number of power banks 51 may be provided.

### Method of Charging a Power Source

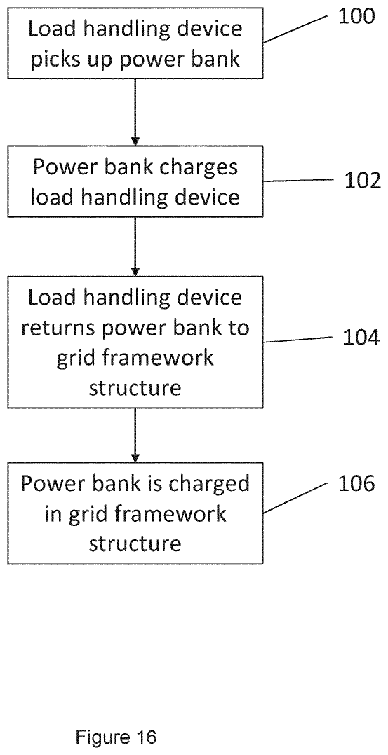

FIG. 16 is a flowchart illustrating a method of charging a main rechargeable power source 53 in a load handling device 31. Charging the main rechargeable power source 53 may be required, for example, if the main rechargeable power source 53 is depleted and no longer has enough charge to power the driving mechanism 38 of the load handling device 31.

In a first step 100, the load handling device 31 picks up a power bank 51 and lifts it into the container-receiving space 49 of the load handling device 31. In some examples, the load handling device 31 can take the power bank 51 to a different part of the grid. The load handling device 31 can move to a part of the track system 13 that is not currently in use, for example to keep out of the way of other load handling devices 31 that are retrieving storage containers 9 to fulfil customer orders. Alternatively, there may be specific charging areas provided on the track system 13. In some examples, these specific charging areas can be located near data exchange points (e.g. li-fi), so that load handling devices 31 can upload data or download updates while charging.

The load handling device 31 may take advantage of opportunities for charging that do not reduce the available time for performing operations on the grid framework structure 1. For example, the load handling device 31 may take a power bank 51 while moving to a different part of the track system 13 in preparation for carrying out another operation, or while waiting for other load handling devices 31 to remove storage containers 9 above a target storage container 9 in a stack 11, or while there is a lull in demand for load handling device 31 to retrieve storage containers 9.

In a second step 102, the power bank 51 charges the main rechargeable power source 53 of the load handling device 31. The auxiliary rechargeable power source 55 in the power bank 51 can be chosen to have the advantage of high power density (e.g. supercapacitors), so the charging takes place over a relatively short time. This reduces or eliminates the need for downtime while charging. Depending on the capacity and state of charge of the main rechargeable power source 53 of the load handling device 31, more than one power bank 51 may be needed to fully charge the main rechargeable power source 53 in the load handling device 31.

Alternatively the auxiliary rechargeable power source 55 in the power bank 51 can be chosen to have the advantage of high energy density (e.g. rechargeable batteries). This may have the advantage that a single power bank 51 can impart a full charge to the main rechargeable power source 53 of the load handling device 31.

In a third step 104, the load handling device 31 returns the power bank 51 to a stack 11 in the grid framework structure 1. This can be the same stack 11 where the power bank 51 was previously located, or a different stack 11.

In a fourth step 106, the auxiliary rechargeable power source 55 in the power bank 51 is recharged in the grid framework structure 1.

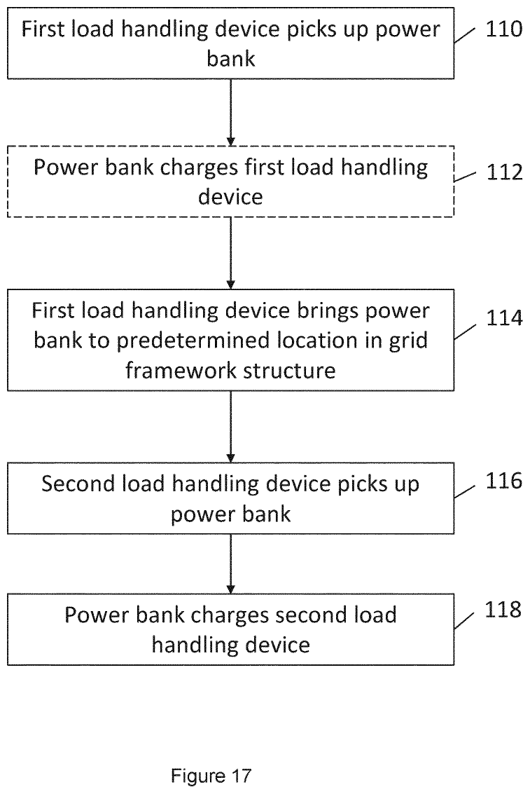

FIG. 17 is a flowchart illustrating a method of a first load handling device 31 bringing a power bank 51 to a predetermined location, and then a second load handling device 31 charging from the power bank 51. Again, charging the main rechargeable power source 53 of the second load handling device 31 may be required, for example, if the main rechargeable power source 53 is partially depleted and no longer has enough charge to power the driving mechanism 38 of the second load handling device 31 to move to another power bank 51 or a charge station.

In a first step 110, the first load handling device 31 picks up a power bank 51 and lifts it into the container-receiving space 49 of the first load handling device 31.

Optionally, in a second step 112, the power bank charges the first load handling device 31.

In a third step 114, the first load handling device 31 brings the power bank 51 to a predetermined location in the grid framework structure 1. The predetermined location could be a grid cell adjacent to or located close to the second load handling device 51. Advantageously, this method allows the second load handling device 31 to reach the power bank 51 easily, without the need to travel to another power bank or charge station located remotely, e.g. on a different part of the track structure 13. For example, if the main power source 53 of the second load handling device 31 is partially depleted and only has enough charge to move a short distance, the second load handling device 31 may be able to travel to the predetermined location, rather than being stranded on the track system 13 because it does not have enough power to travel to another power bank 51 or charge station.

In a fourth step 116, the second load handling device 31 picks up the power bank 51. The predetermined location may be chosen to be adjacent to or close to the second load handling device 31, so the second load handling device 31 does not have far to travel.

In a fifth step 118, the power bank 51 charges the second load handling device.

The method may further comprise the steps (not shown) of the second load handling device returning the power bank to a stack in the grid framework structure, and the power bank being recharged in the grid framework structure.

An advantage of power banks 51 is that they are a cheaper solution than charge stations or exchange stations for main rechargeable power sources 53, and fit into the existing grid framework structure 1 without the need for specialized equipment that significantly reduces available storage space.

Another advantage is that servicing and maintenance of the power banks 51 is straightforward. A power bank 51 in need of maintenance can be picked up by a load handling device 31 and removed from the grid framework structure 1, where it can be taken to a maintenance area.

### Definitions

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the 25 possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” 30 and its derivatives are intended to include the possibilities of direct and indirect contact.

For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the 5 possibility that x is directly mounted on y, with no intervening components, and the possibility that x is indirectly mounted on y, with one or more intervening components.

In this document, the word “comprise” and its derivatives are intended to have an inclusive rather than an exclusive meaning. For example, “x comprises y” is intended to include the possibilities that x includes one and only one y, multiple y's, or one or 10 more y's and one or more other elements. Where an exclusive meaning is intended, the language “x is composed of y” will be used, meaning that x includes only y and nothing else.

In this document, the term “fully charged” applied to a rechargeable power source means that the rechargeable power source is provided with its rated charge. For a battery, this means that the battery voltage is the rated voltage. The term “depleted” applied to a rechargeable power source means that there is a predetermined residual charge left in the rechargeable power source. For a battery, this means that the battery voltage has dropped below the rated voltage to a predetermined residual voltage.

1-27. (canceled)

28. A power bank for charging a load handing device operative on a grid framework structure, the grid framework structure including:
i) a track system including a plurality of tracks arranged in a grid pattern;
ii) a supporting framework structure supporting the track system; and
iii) a plurality of stacks of storage containers arranged in a plurality of storage columns located below the track system;
the load handling device including:
1) a main rechargeable power source;
2) a container-receiving space configured to receive a storage container; and
3) a container-lifting device including a container-engaging assembly configured to engage with the storage container, and a driving mechanism configured to lift the storage container into the container-receiving space,
wherein the power bank is configured to be one or more storage containers for a grid framework structure, and the power bank comprises:
an auxiliary rechargeable power source; and
at least one power transfer means electrically coupled to the auxiliary rechargeable power source; and
wherein the at least one power transfer means is configured to electrically couple to a load handling device so as to transfer electrical power from the auxiliary rechargeable power source to the load handing device when the power bank is received within a container-receiving space of the load handling device.

29. The power bank as claimed in claim 28, wherein the at least one power transfer means comprises:
at least one electrical coupling element, the at least one electrical coupling element including a primary charge providing element configured to electrically couple the power bank to a load handling device.

30. The power bank as claimed in claim 28, wherein the auxiliary rechargeable power source in the power bank comprises:
one or more supercapacitors.

31. The power bank as claimed in claim 30, wherein the one or more supercapacitors comprise:
a plurality of supercapacitor elements connected in series, with each supercapacitor element including a plurality of supercapacitors connected in parallel.

32. The power bank as claimed in claim 28, wherein the auxiliary rechargeable power source comprises:
a rechargeable battery.

33. The power bank as claimed in claim 29, wherein the at least one electrical coupling element comprises:
a secondary charge providing element for electrically coupling with a vertically adjacent power bank in a stack, such that, when arranged in a stack of power banks, power will be transferred from the power bank to the vertically adjacent power bank.

34. The power bank as claimed in claim 29, wherein the at least one electrical coupling element comprises:
a secondary charge receiving element for electrically coupling with a vertically adjacent power bank in the stack, such that, when arranged in a stack of power banks, power will be transferred to the power bank from the vertically adjacent power bank.

35. A power bank as claimed in claim 28, in combionation with a load handling device comprising:
1) a main rechargeable power source;
2) a container-receiving space configured to receive the power bank;
3) a container-lifting device including a container-engaging assembly configured to engage with the power bank, and a driving mechanism configured to lift the power bank into the container-receiving space, and
wherein the load handling device is configured to receive power from the power bank when the power bank is received within the container-receiving space of the load handling device.

36. The load handling device as claimed in claim 35, wherein the container-receiving space comprises:
a charge receiving element for receiving power from the power bank to charge the main rechargeable power source.

37. A power bank and load handling device of claim 35, in combination with a storage and retrieval system comprising:
A) a grid framework structure including:
i) a track system including a plurality of tracks arranged in a grid pattern;
ii) a supporting framework structure supporting the track system; and
iii) a plurality of stacks of storage containers arranged in a plurality of storage columns located below the track system; and
B) the a load handling device, wherein the container-receiving space is configured to receive a storage container, the container-engaging assembly is configured to engage with a storage container, and the driving mechanism is configured to lift the storage container from a stack of the plurality of stacks into the container-receiving space;
wherein one or more of the storage containers in the stack is the power bank.

38. The storage and retrieval system as claimed in claim 37, wherein the power bank comprises:
an outer casing with dimensions substantially same as dimensions of the storage containers.

39. The storage and retrieval system as claimed in claim 37, wherein one or more of the storage columns comprises:
a charging surface including a charge providing element for charging a power bank when the charging surface is electrically coupled with the power bank.

40. The storage and retrieval system as claimed in claim 39, wherein the charging surface comprises:
a base charging plate such that the power bank electrically couples with the base charging plate when the power bank is mounted on the base charging plate.

41. The storage and retrieval system as claimed in claim 39, wherein the charging surface comprises:
a bus bar extending upwardly along the storage column, such that the bus bar electrically couples with a side of the power bank.

42. The storage and retrieval system as claimed in claim 39, wherein the at least one electrical coupling element of the power bank comprises:
a primary charge receiving element configured to receive electrical power from the charge providing element of the charging surface.

43. The storage and retrieval system as claimed in claim 35, comprising:
a plurality of power banks arranged in a stack, wherein the at least one electrical coupling element of each of the plurality of power banks includes a secondary charge receiving element and a secondary charge providing element, wherein each of the respective secondary charge providing and receiving elements of the power banks electrically couple with each other in the stack to transfer charge between vertically adjacent power banks in the stack.

44. A method for transferring power to a load handling device operative in a storage and retrieval system as claimed in claim 37, the method comprising:
a) moving the load handling device on the track system to a location above a stack a power bank; and
b) lifting the power bank into the container-receiving space of the load handling device using the container-lifting device, such that the at least one power transfer means electrically couples with the charge receiving element of the load handling device, so that power is transferred from the auxiliary power source in the power bank to the main rechargeable power source of the load handling device.

45. The method of claim 44, comprising:
c) the load handling device returning the power bank to a stack in the grid framework structure.

46. The method of claim 45, comprising:
d) recharging the power bank in the stack of the grid framework structure.
